(19) United States
(12) Patent Application Publication
(10) Pub. No.: US 2011/0110699 A1
(43) Pub. Date: May 12, 2011

(54) PRINTER

(75) Inventors: Xiaojie Tang, Shandong (CN); Lei Zheng, Shandong (CN)

(73) Assignee: SHANDONG NEW BEIYANG INFORMATION TECHNOLOGY CO., LTD., Weihai, Shandong (CN)

(21) Appl. No.: 12/990,906

(22) PCT Filed: Dec. 3, 2008
(86) PCT No.: PCT/CN2008/073312

§ 371 Date: Jan. 28, 2011

(30) Foreign Application Priority Data
May 4, 2008 (CN) 200810094710.X

(51) Int. Cl. B41J 29/00

(52) U.S. Cl. 400/663

(57) ABSTRACT

A printer comprises: a printer body (1), a top cover (2) hinged to the rear portion of the printer body, and a cover-opening member (3). An opening (21) is formed in the middle of the upper wall of the top cover. The lower end of the cover-opening member (3) is passed through the opening (21) and engaged with the printer body (1). The middle of the cover-opening member (3) is hinged to the top cover (2). The lower end of the cover-opening member can be engaged with or disengaged from the printer body (1) as long as a user rotates the cover-opening member upward. The printer has a simple construct, and the user can open the top cover in a single operation.

The present application claims the priority of the Chinese patent application No. 200810094710.X filed with the Chinese Patent Office on May 4, 2008 and entitled “Printer”, and all the contents thereof are incorporated by reference into the present application.

### FIELD OF THE INVENTION

The present invention relates to printing devices, in particular, to a printer.

### BACKGROUND ART

For a printer using a printing roll paper, a paper holder for accommodating a printing roll paper is usually provided inside the printer. When the printing paper is used up, the user opens the upper cover of the printer by opening an upper cover opening mechanism of the printer.

FIG. 1 is a schematic view of the external structure of a traditional printer. As illustrated in the figure, an upper cover 100 of the printer is hinged to a printer body 300, the upper cover 100 of the printer can be opened or closed relative to the printer body 300; a locking shaft (not shown in the figure) is provided inside the upper cover 100 of the printer, a locking hook (not shown in the figure) is provided inside the printer body 300; an opening spanner 200 has one end connected with the locking hook and the other end extending from the external surface of the printer body 300; the locking hook is engaged with the locking shaft, such that the upper cover 100 is locked and closed with respect to the printer body 300. When it is required to open the upper cover 100 of the printer to change a printing paper roll, the operator moves the opening spanner 200, the locking hook synchronously rotates and is disengaged from the locking shaft, the upper cover 100 of the printer is under the non-locking state, at this time, holds the upper cover 100 of the printer to rotate until the upper cover 100 of the printer is completely open relative to the printer body 300.

The opening mechanism of the above mentioned traditional printer has the defect of inconvenient operation. After the operator moves the opening spanner 200, the upper cover 100 of the printer can only be opened at a very small angle in relation to the printer body 300, which cannot meet the needs of changing printing paper roll. The operator needs to further hold the edge of the upper cover 100 of the printer to rotate, and the upper cover 100 of the printer is completely open in relation to the printer body 300. That is, a second operation is needed to complete the opening of the upper cover of the printer.

### SUMMARY OF THE INVENTION

In view of the above defect, the technical problem settled by the present invention lies in: providing a printer with an upper cover opening mechanism which has a simple structure and which is convenient in operation.

The printer provided in the present invention comprises a printer body, a top cover hinged to the rear portion of the printer body, and a cover-opening member, wherein an opening is provided in the middle of the upper wall of the top cover, the lower end of the cover-opening member passes through the opening of the top cover and engages with the printer body; the middle of the cover-opening member is hinged to the top cover, the lower end of the cover-opening member can be engaged with or disengaged from the printer body as the cover-opening member is rotated upward.

Preferably, the top cover is provided in its upper surface with a recessed accommodation portion, the cover-opening member on the top cover is opposite to the recessed accommodation portion, and there is gap between the cover-opening member and the recessed accommodation portion.

The recessed accommodation portion and the opening on the top cover have a non-communicating relation therebetween.

The recessed accommodation portion at a side adjacent to the opening has a baffle.

Preferably, the cover-opening member is composed of a spanner and a locking hook mechanism, the middle of the spanner is hinged to the top cover, the locking hook mechanism comprises a locking hook and a locking shaft engaged with the locking hook, wherein the locking hook is provided at a lower end of the spanner with the locking shaft provided inside the printer body, or the locking hook is provided inside the printer body with the locking shaft provided at the lower end of the spanner.

Preferably, an elastic member is included, the elastic member having a predetermined deformation and being fixedly arranged between the spanner below the hinging point and the top cover, for realizing the locking between the spanner and the printer body.

The elastic member is an extension spring or a torsion spring.

Preferably, the cover-opening member is composed of a spanner assembly and a locking hook mechanism, the spanner assembly comprises a spanner and a force transmission rod, the middle of the spanner is hinged to the top cover, the middle of the force transmission rod is hinged to the top cover, and an upper end of the force transmission rod is abuted against a lower end of the spanner; the locking hook mechanism comprises a locking hook and a locking shaft engaged with the locking hook, wherein the locking hook is provided at a lower end of the force transmission rod with the locking shaft provided inside the printer body, or the locking hook is provided inside the printer body with the locking shaft provided at the lower end of the force transmission rod; the lower end of the spanner can push the upper end of the force transmission rod to realize disengagement between the locking hook or the locking shaft at the lower end of the force transmission rod and the locking shaft or locking hook inside the printer body.

Preferably, an elastic member is included, the elastic member having a predetermined deformation and being fixedly arranged between the force transmission rod below the hinging point and the top cover, for realizing the locking between the force transmission rod and the printer body.

The elastic member is an extension spring or a torsion spring.

Comparing the printer provided by the present invention with the prior art, in the solution of the present invention, the cover-opening member is hinged to the top cover, and the lower end of the cover-opening member is engaged with the printer body. In cases where the printing paper roll needs to be changed, the operator rotates the cover-opening member at the outer side, such that the lower end of the cover-opening member is disengaged from the printer body, at this time, pulls the cover-opening member so that the top cover is completely open in relation to the printer body. With the technical solution of the present invention, the operator can effectively open the top cover in a single operation, which simplifies the opening of the top cover.

In a preferred embodiment of the present invention, the recessed accommodation portion provided on the top cover may provide space for the user's operation. Meanwhile, the baffle provided in the recessed accommodation portion divides the recessed accommodation portion into two cavities which do not communicate with each other, which can prevent foreign matters drops from the end of the cover-opening member to the interior of the printer body.

In another preferred embodiment of the present invention, the elastic member is fixedly arranged between the cover-opening member below the hinging point and the printer body. In assembly, the elastic member is firstly pre-stretched or pre-compressed to ensure the engagement between the cover-opening member and the printer body in a close state.

### BRIEF DESCRIPTION OF ACCOMPANYING DRAWINGS

The following is detailed description on the present inventive in conjunction with the accompanying drawings and embodiments.

FIG. 1 is a schematic view of the outer structure of a traditional printer;

FIG. 2 is a three-dimensional view of a printer of the present invention;

FIG. 3 is a sectional view of I-I in FIG. 2;

FIG. 4 is a schematic view of the structure of the cover-opening member 3a in Embodiment 1 of the present invention;

FIG. 5 is a view of FIG. 4 in D direction;

FIG. 6 is a schematic view of the opening state of the top cover 2 of the printer of the present invention;

FIG. 7 is a schematic view of the structure in which the cover-opening member and related components are reversely arranged in Embodiment 1;

FIG. 8 is a schematic view of the structure of the cover-opening member 3b in Embodiment 2 of the present invention; and

FIG. 9 is a schematic view of the structure in which the cover-opening member and related components are reversely arranged in Embodiment 2.

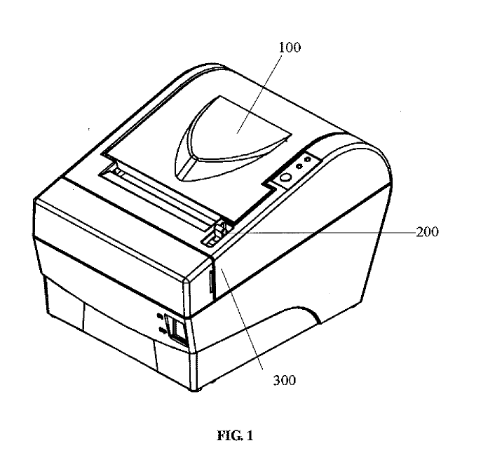

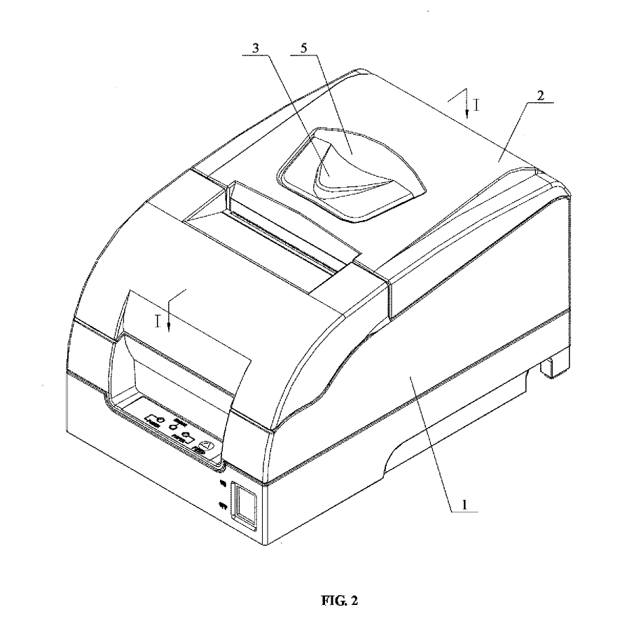

In FIGS. 2-9:

1—printer body; 2—top cover; 21—opening; 22a, 22b—hinging shaft; 3a, 3b—cover-opening member; 31a—spanner; 321a, 321b—locking hook; 31b—spanner assembly; 311b—spanner; 312b—force transmission rod; 322a, 322b—locking shaft; 4—elastic member; 5—recessed accommodation portion; 51—baffle; 6a, 6b—hinging hole; 7—paper holder.

### DETAILED DESCRIPTION OF THE INVENTION

Referring to FIG. 2, it is a schematic view of the entire structure of the printer of the present invention.

As shown in FIG. 2, the present invention mainly comprises a printer body 1, a top cover 2 hinged to the rear portion of the printer body 1, and a cover-opening member 3, wherein in the printer of the present invention, the structure of and connection relation between the main components, such as print head, paper supplying roller, cutter, driving motor, are identical to those in the prior art, and thus, no description on them is provided here.

The key point in design of the present invention lies in the cover-opening member 3, in combination with the structure design of the printer body 1 and the top cover 2, the top cover 2 is completely open in relation to the printer body 1 by rotating the cover-opening member upward. The present invention is described in detail in conjunction with two embodiments as follows.

### Embodiment 1

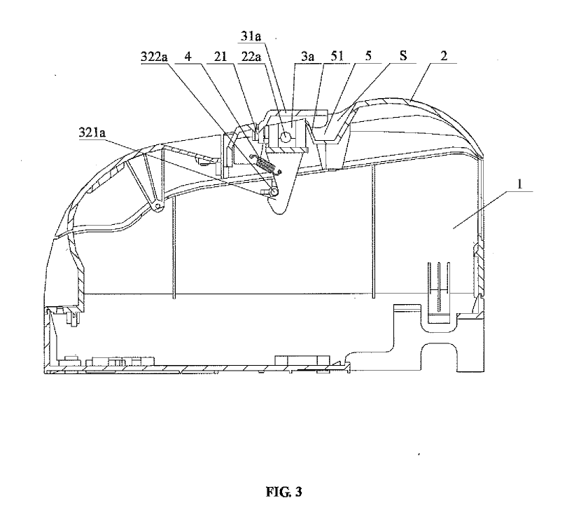

Referring to FIG. 3, it is a sectional view of I-I in FIG. 2, and to clearly describe the technical solution of the present invention, FIG. 3 only keeps the main components relevant to the present invention. As shown in FIG. 3, an opening 21 is formed in the middle of the upper wall of the top cover 2, the lower end of the cover-opening member 3a pass through the opening 21 in the top cover 2 and engages with the printer body 1; the middle of the cover-opening member 3a is hinged to the top cover 2. The lower end of the cover-opening member can be engaged with or disengaged from the printer body 1 as long as the cover-opening member 3a on the top cover 2 is rotated upward, that is, the cover-opening member 3a rotates about a hinging point at it middle part.

Further, as shown in FIGS. 2 and 3, the top cover 2 is provided with a recessed accommodation portion 5 in its upper surface, and there exists a gap S between the cover-opening member 3a on the top cover 2 and the recessed accommodation portion 5.

It needs to described that when the cover-opening member 3a on the top cover 2 is embedded into the recessed accommodation portion 5, the recessed accommodation portion 5 can provide a operating space for a user, and when the top cover 2 needs to be opened, the user can complete the operation of opening the cover through the gas S between the cover-opening member 3a and the recessed accommodation portion 5.

To meet a dustproof need, the recessed accommodation portion 5 in the top cover 2 is not in communication with the opening 21, and specifically, the recessed accommodation portion 5 has a baffle at a side adjacent to the opening 21. Thus the dust and foreign matters falling in via the end of the cover-opening member 3a can be prevented from entering the inside of the printer body 1 via the opening 21.

Actually, the recessed accommodation portion 5 in the top cover 2 is not in communication with the opening 21, which is not limited to the straight line type baffle shown in the figures and can also be arc shape baffle as long as it meets use needs, which is not described here one by one.

Further, the cover-opening member 3a consists of a spanner 31a and a locking hook mechanism (not shown in the figures), the spanner 31a is hinged with the top cover 2 at its middle part, and the locking hook mechanism comprise a locking hook 321a and a locking shaft 322a engaged with the locking hook 321a, wherein, the locking hook 321a is provided at the lower end of the spanner 31a, and the locking shaft 322a is provided within the printer body 1. Wherein, the locking hook is moveable end and the locking shaft is a fixed end.

Actually, the positions of the above locking hook and the locking shaft realizing the engagement and cooperation can also be exchanged, that is, the locking shaft is provided at the lower end of the spanner 31a, and the printer body 1 is fixedly provided therein with the locking hook (not shown in the figure) engaging with the locking shaft at the lower end of the spanner 31a. Wherein, the locking shaft is moveable end and the locking hook is a fixed end.

Of course, the structure on the printer body 1 that cooperates with the locking hook 321a at the lower end of the spanner 31a to realize engagement is not limited to the design of the above locking shaft 322a. It can also be a clamping slot structure (not shown in the figure) provided at a corresponding position at the printer body 1 cooperating with the locking hook 321a, and it is understandable that it is fine as long as the use need is met and the engagement between the spanner 31a and the printer body 1 is realized.

The present invention also comprises an elastic member 4 which has a predetermined deformation and is fixedly provided between the spanner 31a below the hinging point and the top cover 2 for realizing the locking between the spanner 31a and the printer body 1 and thus preventing loosening of the above engagement due to vibration during the printing.

As shown in FIG. 3, in this embodiment, the elastic member 4 is an extension spring which is provided between the spanner 31a at a head side of the locking hook and the top cover 2, and the extension spring is hung at the spanner 31a at its one end and is hung at the top cover 2 at the other end; when the top cover 2 is closed relative to the printer body 1, reliable engagement and fixation between the spanner 31a and the printer body 1 is achieved by a prestretching deformation of the extension spring.

It needs to described that the elastic member 4 can also be selected according to the internal space of the printer body 1, for example, it can be a compression spring provided selectively between the spanner 31a at an opposite side of the head of the locking hook and the top cover 2; it can also be a torsion spring whose center passes through the hinging shaft of the spanner 31a, and the torsion spring is clamped at the top cover 2 above the hinging point at one end and is clamped at the top cover 2 below the hinging point of the spanner 31a at the other end. Wherein, the detailed structures and the connection relationship of the compression spring and the torsion spring are not shown in the figures.

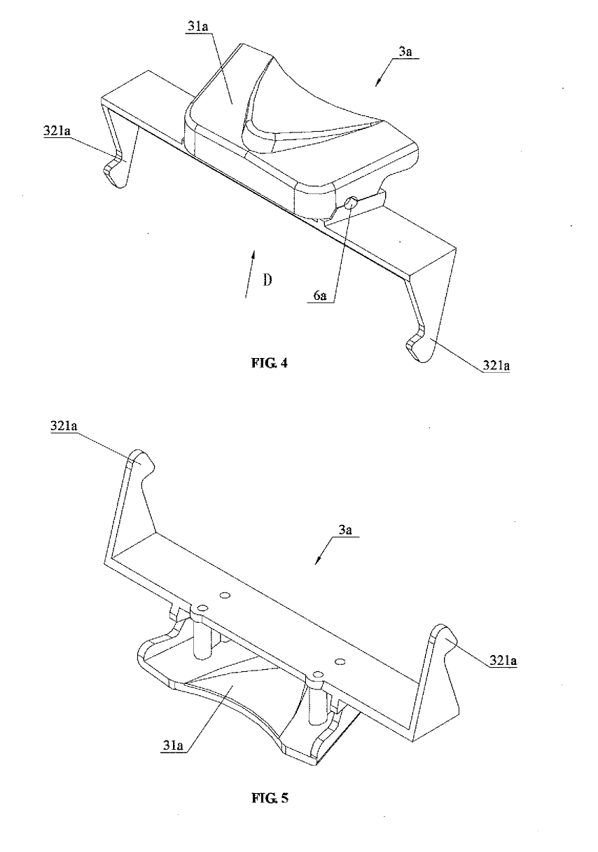

Of course, the elastic member can also be a plastic elastomer, such as an elastic rubber and TPU, as long as it is a material which can have plastic deformation and store huge energy.

Wherein, for the detailed structure of the cover-opening member 3a in this embodiment, please refer to FIGS. 4 and 5, and FIG. 4 is a schematic view of the structure of the cover-opening member 3a in Embodiment 1 of the present invention; and FIG. 5 is a view of FIG. 4 in D direction.

As shown in FIG. 4, the locking hooks 321a are provided symmetrically at two sides of the spanner 31a, and of course, according to the internal space of the printer body 1 the locking hooks 321a can be only provided at one side. As shown in FIG. 5, the spanner 31a has an upper-lower split structure which is fixedly connected via a bolt, the top cover 2 is provided with a hinging shaft 22a (which is shown in FIG. 3), and a hinging hole 6a matching the hinging shaft 22a on the top cover 2 is formed at a joint of the upper-lower split structure of the spanner 31a.

During assembling, the upper and the lower portions of the spanner 31a are first clamped at the hinging shaft 22a, then a bolt is used to fixedly connect the spanner 31a and the hinging shaft 22a; such a split structure design has advantages of convenient processing of parts and good assembling process.

The opening process of the top cover 2 of the printer in the embodiment will be described hereinafter in conjunction with FIG. 3. When the top cover 2 needs to be opened, please pull the spanner 31a upward anticlockwise, and then the spanner 31a overcomes the pulling force of the elastic member 4 and rotates about the hinging shaft 22a, the locking hook 321a at the lower end of the spanner 31a disengages from the locking shaft 322a at the printer body 1, and now hold the spanner 31a and pull the top cover 2 upward continuously, and thereby the top cover 2 can be opened completely relative to the printer body 1.

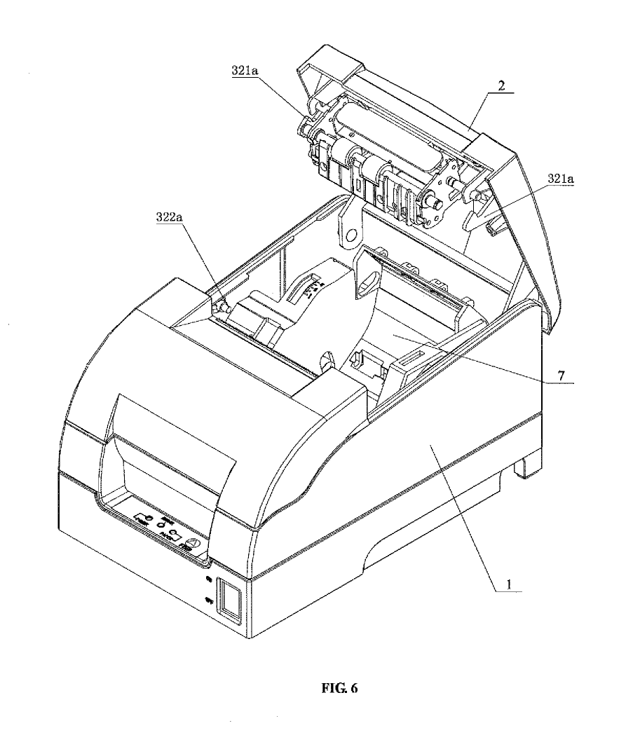

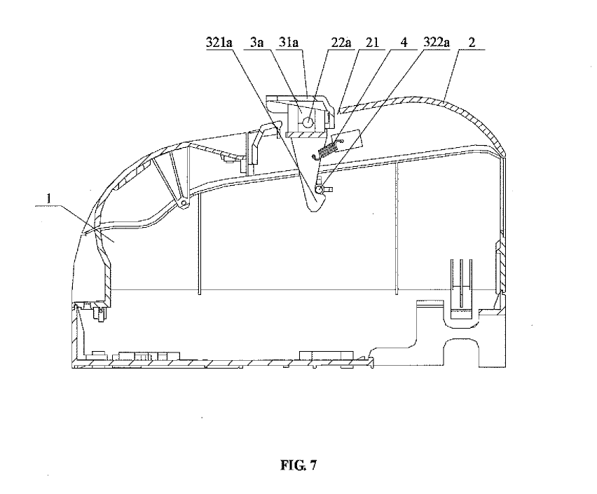

Referring to FIG. 6, it is a schematic view of the opening state of the top cover 2 of the printer of the present invention. Now the paper holder 7 inside the printer body 1 is completely exposed so that the user can conveniently change a printing medium.

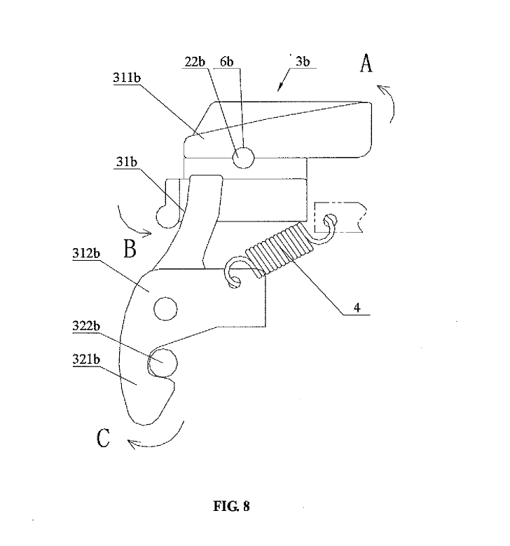

In addition, the operation of opening the top cover can also be completed by pulling the spanner 31a clockwise about the hinging shaft 22a, and referring to FIG. 7, it is a schematic view of the structure in which the cover-opening member and related components are reversely arranged in Embodiment 1. As shown in FIG. 7, the positions and the connection relationship of the main components such as the spanner 31a, the locking hook 321a, the locking shaft 322a and the elastic member 4 are the mirror arrange of the corresponding components shown in FIG. 3 along front and rear directions.

### Embodiment 2

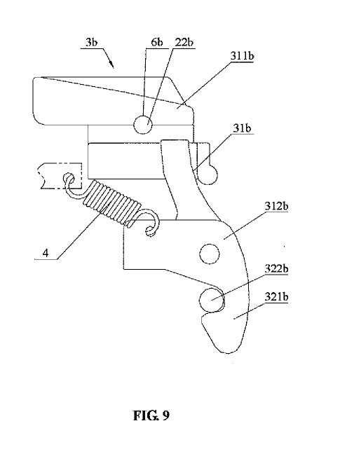

Referring to FIG. 8, it is a schematic view of the structure of the cover-opening member 3b in this embodiment.

Being different from embodiment 1, in this embodiment the cover-opening member 3b consists of a spanner assembly 31b and a locking hook mechanism (not shown in the figures), and the spanner assembly 31b comprises a spanner 311b and a force transmission rod 312b, and the spanner 311b is hinged with the top cover 2 at its middle portion, as shown in the figures, the force transmission rod 312b is hinged at its middle portion with the top cover 2 below the spanner 311b (based on the internal structure of the printer, the hinging point between the force transmission rod 312b and the top cover 2 is not limited below the spanner 311b and can be higher than or at the same height with the hinging point between the spanner 311b and the top cover 2), and the force transmission rod 312b abuts against the lower end of the spanner 311b at its upper end; the locking hook mechanism comprises a locking hook 321b and a locking shaft 322b engaging with the locking hook 321b, wherein, the locking hook 321b is provided at the lower end of the force transmission rod 312b, and the locking shaft 322b is provided within the printer body 1; the lower end of the spanner 311b can push the upper end of the force transmission rod 312b to realize the disengagement of the locking hook 321b at the lower end of the force transmission rod 312b from the locking shaft 322b within the printer body 1.

Likewise, the positions of the above locking hook and the locking shaft realizing the engagement and operation can also be exchanged, that is, the locking shaft is provided at the lower end of the force transmission rod 312b, and the printer body 1 is fixedly provided therein with the locking hook (not shown in the figure) engaging with the locking shaft at the lower end of the force transmission rod 312b, and it is understandable that it is fine as long as the use need is met and the engagement between the force transmission rod 312b and the printer body 1 is realized.

In addition, this embodiment further comprises an elastic member 4 which has a predetermined deformation and is fixedly provided between the force transmission rod 312b below the hinging point and the top cover 2 for realizing the locking between the force transmission rod 312b and the printer body 1 and thus preventing loosening of the above engagement.

As shown in FIG. 8, the elastic member in this embodiment is also an extension spring which is provided between the force transmission rod 312b at a head side of the locking hook and the top cover 2, and the extension spring is hung at the force transmission rod 312b at its one end and is hung at the top cover 2 at the other end; when the top cover 2 is closed relative to the printer body 1, reliable engagement and fixation between the force transmission rod 312b and the printer body 1 is achieved by a prestretching deformation of the extension spring.

Further, the top cover 2 is provided with a hinging shaft 22b, and the spanner 311b can have an upper-lower split structure which is fixedly connected via a bolt, and a hinging hole 6b matching the hinging shaft 22b on the top cover 2 is formed at a joint of the upper-lower split structure of the spanner 311b.

Likewise, during assembling, the upper and the lower portions of the spanner 311b are first clamped at the hinging shaft 22b respectively, then a bolt is used to fixedly connect the spanner 311b and the hinging shaft 22b.

The other constitution and connection relationship of this embodiment is the same with embodiment 1 and thus omitted herein.

The opening process of the top cover of the printer according to this embodiment is described as follows: the spanner 311b is rotated (the direction shown by arrow A in the figure), and then the lower end of the spanner 311b rotates about the hinging shaft 22b (the direction shown by arrow B in the figure); then the head of the lower end of the spanner 311b pushes the head of the upper end of the force transmission rod 312b so that the locking hook 321b overcomes the elastic force of the elastic member 4 and rotates about the hinging point of the force transmission shaft 312b (the direction shown by arrow C), and in this way the locking hook 321b at the force transmission rod 312b disengages from the locking shaft 11b. Now the spanner 311b is pulled upward continuously and then the top cover 2 can be opened completely relative to the printer body 1.

Likewise, the operation of opening the top cover can also be completed by pulling the spanner 31b clockwise about the hinging shaft 22b, and referring to FIG. 9, it is a schematic view of the structure in which the cover-opening member and related components are reversely arranged in Embodiment 2. As shown in FIG. 9, the positions and the connection relationship of the main components such as the spanner 311b, the locking hook 321b, the locking shaft 11b, the force transmission rod 312b and the elastic member 4 are the mirror arrange of the corresponding components shown in FIG. 8 along front and rear directions.

The above descriptions are just preferable embodiments of the present invention, and it should be indicated that one of ordinary skill in the art can make improvements and modifications without departing from the principle of the present invention, and such improvements and modifications should be also contained within the scope of protection of the present invention.

1. A printer comprising a printer body and a top cover hinged to the rear portion of the printer body, and further comprising a cover-opening member, wherein an opening is provided in the middle of the upper wall of the top cover, the lower end of the cover-opening member passes through the opening of the top cover and engages with the printer body; the middle of the cover-opening member is hinged to the top cover, and the lower end of the cover-opening member disengages from the printer body as the cover-opening member is rotated upward.

2. The printer according to claim 1, wherein the top cover is provided with a recessed accommodation portion in its upper surface, the cover-opening member on the top cover is opposite to the recessed accommodation portion, and there is gap between the cover-opening member and the recessed accommodation portion.

3. The printer according to claim 2, wherein the recessed accommodation portion and the opening on the top cover have a non-communicating relationship therebetween.

4. The printer according to claim 3, wherein the recessed accommodation portion at a side adjacent to the opening has a baffle.

5. The printer according to claim 1, wherein the cover-opening member is composed of a spanner and a locking hook mechanism,
the middle of the spanner is hinged to the top cover,
the locking hook mechanism comprises a locking hook and a locking shaft engaged with the locking hook, wherein the locking hook is provided at a lower end of the spanner with the locking shaft provided inside the printer body, or the locking hook is provided inside the printer body with the locking shaft provided at the lower end of the spanner.

6. The printer according to claim 5, further comprising an elastic member having a predetermined deformation and being fixedly arranged between the spanner below the hinging point and the top cover, for realizing the locking between the spanner and the printer body.

7. The printer according to claim 6, wherein the elastic member is an extension spring or a torsion spring.

8. The printer according to claim 1, wherein the cover-opening member is composed of a spanner assembly and a locking hook mechanism,
the spanner assembly comprises a spanner and a force transmission rod, the middle of the spanner is hinged to the top cover, the middle of the force transmission rod is hinged to the top cover, and an upper end of the force transmission rod abuts against the lower end of the spanner;
the locking hook mechanism comprises a locking hook and a locking shaft engaging with the locking hook, wherein the locking hook is provided at a lower end of the force transmission rod with the locking shaft provided inside the printer body, or the locking hook is provided inside the printer body with the locking shaft provided at the lower end of the force transmission rod; and
the lower end of the spanner can push the upper end of the force transmission rod to realize disengagement between the locking hook or the locking shaft at the lower end of the force transmission rod and the locking shaft or locking hook inside the printer body.

9. The printer according to claim 8, further comprising an elastic member having a predetermined deformation and being fixedly arranged between the force transmission rod below the hinging point and the top cover, for realizing the locking between the force transmission rod and the printer body.

10. The printer according to claim 9, wherein the elastic member is an extension spring or a torsion spring.

11. The printer according to claim 2, wherein the cover-opening member is composed of a spanner and a locking hook mechanism,
the middle of the spanner is hinged to the top cover,
the locking hook mechanism comprises a locking hook and a locking shaft engaged with the locking hook, wherein the locking hook is provided at a lower end of the spanner with the locking shaft provided inside the printer body, or the locking hook is provided inside the printer body with the locking shaft provided at the lower end of the spanner.

12. The printer according to claim 3, wherein the cover-opening member is composed of a spanner and a locking hook mechanism,
the middle of the spanner is hinged to the top cover,
the locking hook mechanism comprises a locking hook and a locking shaft engaged with the locking hook, wherein the locking hook is provided at a lower end of the spanner with the locking shaft provided inside the printer body, or the locking hook is provided inside the printer body with the locking shaft provided at the lower end of the spanner.

13. The printer according to claim 4, wherein the cover-opening member is composed of a spanner and a locking hook mechanism,
the middle of the spanner is hinged to the top cover,
the locking hook mechanism comprises a locking hook and a locking shaft engaged with the locking hook, wherein the locking hook is provided at a lower end of the spanner with the locking shaft provided inside the printer body, or the locking hook is provided inside the printer body with the locking shaft provided at the lower end of the spanner.

14. The printer according to claim 2, wherein the cover-opening member is composed of a spanner assembly and a locking hook mechanism,
the spanner assembly comprises a spanner and a force transmission rod, the middle of the spanner is hinged to the top cover, the middle of the force transmission rod is hinged to the top cover, and an upper end of the force transmission rod abuts against a lower end of the spanner;
the locking hook mechanism comprises a locking hook and a locking shaft engaging with the locking hook, wherein the locking hook is provided at a lower end of the force transmission rod with the locking shaft provided inside the printer body, or the locking hook is provided inside the printer body with the locking shaft provided at the lower end of the force transmission rod; and
the lower end of the spanner can push the upper end of the force transmission rod to realize disengagement between the locking hook or the locking shaft at the lower end of the force transmission rod and the locking shaft or locking hook inside the printer body.

15. The printer according to claim 3, wherein the cover-opening member is composed of a spanner assembly and a locking hook mechanism,
the spanner assembly comprises a spanner and a force transmission rod, the middle of the spanner is hinged to the top cover, the middle of the force transmission rod is hinged to the top cover, and an upper end of the force transmission rod abuts against a lower end of the spanner;
the locking hook mechanism comprises a locking hook and a locking shaft engaging with the locking hook, wherein the locking hook is provided at a lower end of the force transmission rod with the locking shaft provided inside the printer body, or the locking hook is provided inside the printer body with the locking shaft provided at the lower end of the force transmission rod; and
the lower end of the spanner can push the upper end of the force transmission rod to realize disengagement between the locking hook or the locking shaft at the lower end of the force transmission rod and the locking shaft or locking hook inside the printer body.

16. The printer according to claim 4, wherein the cover-opening member is composed of a spanner assembly and a locking hook mechanism,
the spanner assembly comprises a spanner and a force transmission rod, the middle of the spanner is hinged to the top cover, the middle of the force transmission rod is hinged to the top cover, and an upper end of the force transmission rod abuts against a lower end of the spanner;
the locking hook mechanism comprises a locking hook and a locking shaft engaging with the locking hook, wherein the locking hook is provided at a lower end of the force transmission rod with the locking shaft provided inside the printer body, or the locking hook is provided inside the printer body with the locking shaft provided at the lower end of the force transmission rod; and
the lower end of the spanner can push the upper end of the force transmission rod to realize disengagement between the locking hook or the locking shaft at the lower end of the force transmission rod and the locking shaft or locking hook inside the printer body.
